(19) United States
(12) Patent Application Publication
(10) Pub. No.: US 2021/0058244 A1
(43) Pub. Date: Feb. 25, 2021

(54) The One-Qubit Pad (OQP) for entanglement encryption of quantum information

(71) Applicant: COMPSECUR SP. Z.O.O., Wroclaw (PL)

(72) Inventors: Janusz JACAK, Wroclaw (PL); Witold JACAK, Wroclaw (PL)

(21) Appl. No.: 16/957,503

(22) PCT Filed: Dec. 31, 2017
(86) PCT No.: PCT/PL2017/000134

§ 371 Date: Jun. 24, 2020

(30) Foreign Application Priority Data
Dec. 30, 2017 (PL) P.424146

(51) Int. Cl. H04L 9/08; H04L 9/06; H04L 9/32; G06N 10/00

(52) U.S. Cl. CPC H04L 9/0858; G06N 10/00; H04L 9/3215; H04L 9/0662

(57) ABSTRACT

The One-Qubit Pad (OQP) protocol and its generic implementing device constitute a novel, maximally efficient scheme for encryption of quantum information with a quantum key of just a single qubit in an arbitrary unknown quantum state. The OQP enables encryption of the quantum information of n qubits register with a single qubit key upon provision of a multi-qubit entanglement between the single qubit key and the n qubits of the quantum message by the iterative application of the CNOT gate on the same key qubit (control input) and subsequent qubits of the message (target input). This results in an entanglement of all n+1 qubits, which locks original quantum information qubits and the single qubit of the key in a jointly entangled state that cannot be disentangled without the single qubit key. In order to decrypt the quantum message (by its disentanglement) one needs to have the qubit key and either reverse the protocol (applying CNOT operations in the reversed order) or simply measure the entangled key qubit and then depending on the outcome either straightforwardly obtain the decrypted quantum message or its quantum negation (dealt with by again applying quantum negation on all of the message qubits thus restoring their original states). The OQP protocol and its implementing device is proposed one hundred years after the classical One-Time Pad (Vernam cipher) was invented in 1917. The main differences between two schemes show how much quantum and clasical information differ. It is of course impossible to unconditionally securely encrypt classical sequence of n bits with just 1 bit of a key or guarantee that the random key that can be used for this purpose of n bits length (same as of the message) could not be copied. In contrast both these features are possible for the quantum information as described upon the proposed invention. The main characteristic of the OQP protocol to use only a single qubit as the key to enable information-theoretic security of n qubits quantum information encryption follows from the introduction in the invention of the multi-qubit entanglement, which is a non-local, topological and non-classical phenomenon giving quantum information significant edge over its classical counterpart. The main application of the OQP protocol and its implementing generic device is to lock quantum information with the single key qubit in order to prevent any unauthorized access to it (not only a classical access upon a measurement, but more importantly a quantum access by a quantum information processing device). This application can be also extended to communication scenario jointly with the Quantum Teleportation, which without OQP requires pre-sharing of n pairs of Bell states between Alice and Bob to securely communicate n qubits long quantum message, whereas in contrast with the OQP protocol just one pair of Bell state is required to securely teleport only the single qubit key for the OQP encrypted quantum message sent through an insecure quantum channel and still be access-protected from Eve (an adversary).

### TECHNICAL FIELD

Quantum information (QI) is a field of both fundamental science and high technology on the overlap of current understanding of physical mechanisms of reality, especially in the regime of unintuitive and non-classical phenomenons of the quantum physics, manifesting in nanoscopic scales of matter and upon matter and light interaction. This field is currently one of the most active areas of the basic research, but on the other hand it carriers many practical applications for the information and communication industry, beyond the reach of classical physics realm, such as the fundamental quantum computational (QC) model qualitatively exceeding its classical counterpart in solving mathematically difficult problems or quantum cryptography [1, 2], including quantum key distribution (QKD) [3-5] offering for the first time in the history the unconditional [6] (information-theoretic) security of complete communication cryptosystems (secure even against quantum computers).

The above mentioned applications of quantum physics in the context of quantum information are already in stage of advanced technical implementations. The first quantum computer has been constructed in 2001: it was though only a 7-qubit NMR implementation able to factorize the number 15 upon the Shor algorithm [7]. Since those beginnings the progress is steady with many achievements (listed e.g. in [8]) yet fully universal and scalable quantum computer has not yet been built and it is currently not known with any certaintity when and if at all it will be built. The progress with commercializing early versions of not universal or not scallable quantum computers is however also dynamic with efforts from the major IT vendors (such as IBM and Microsoft) and the specialized smaller companies (such as DWave currently offering a 2000-qubits superconducting quantum computer following the so called adiabatic quantum computation model [9]). This model of quantum computation is not universal in regard to all quantum algorithms, but still well-suited for specific quantum algorithms such as the quantum annealing adequate to solving optimization problems with a qualitative edge over the classical limits, due to the effect of the quantum tunneling [10]. Basing on the DWave superconducting computers NASA and Google launched recently a joint Quantum Artificial Intelligence Laboratory [11] to develop computational applications for image recognition, graphs optimizing and related problems addressing AI. Even though there is still an ogoing debate if the commercialized large scale quantum processors by DWave are really quantum computers (i.e. whether they are following the quantum computational model, to what claim there is much critique available, and the DWave policy of limited technical and scientific data release is not helping in this respect), the technical development in Quantum Information has become increasingly advanced in recent years (as supported e.g. by data on financing R&D endevours in this domain—cf. the Quantum Technology Flagship of the European Commission with the 1 billion Euro investement in quantum R&D [12], which is many times greater than the previous initiatives).

It should be stressed once again that quantum computation in its current state has not as of yet achieved the universality and scalability properties that would be required for fault-tolerant quantum computation according to the DiVincenzo criteria [13], i.e. for practical applications of quantum algorithms. When (and if) it happens though a great majority (if not all, depending on the progress in quantum computational algorithmics and quantum complexity theory) of difficult (so called asymmetric) mathematical problems, such as e.g. factorization of large numbers into prime factors or finding of discrete logarithm (central in elliptic-curve cryptography)—will become instantly solvable, no matter the input size. Currently factorizing of sufficiently large (e.g. 4096 bits) numbers is out of the reach of all the classical computational power at the disposal of mankind within realistic time-frames [14], and therefore such and similar difficult asymmetric problems are used in wide-spread asymmetric or public-key cryptography (due to its network adequate architecture). Factoring is only one example of such mathematical hard problems rendered easy with the future universal quantum computer (others are e.g. the mentioned finding of discrete logarithm, finding hidden subgroup in group theory, etc.). The public-key cryptography, using asymmetric mathematical relationships between pairs of private and public keys forms a basis of current state-of-the-art common everyday integrity, authentication and secrecy of communication schemes in the Internet warranting security of our private correspondence, financial transaction, web browsing and other online activities. It is therefore prone to quantum computer, and moreover when such computer is built, then all the historic communication will become instantly revealed. The answer to this imminent threat is quantum cryptography in its recently narrowed meaning mainly applying to Quantum Key Distribution (QKD), which provides for unconditionally (information-theoretic) secure communication of quantum information (upon quantum distributed classical key and the classical One-Time Pad cryptographic scheme). However discussion of broadening the scope of quantum cryptography to the most general case of securing quantum information within notions such as quantum encryption and quantum cryptographic keys has been only started in recent years in the literature, mainly in scope of mixing security of quantum information with classical information (dominantly discussing securing of classical information with quantum information, but also referring to securing quantum information with classical information and rather not discussing in detail fully quantumly securing of the quantum information). The herewithin described invention of the proposed One-Qubit Pad protocol and its implementing generic device relates to the most general case of quantum information security in regard to arbitraty unknown quantum states of both quantumly encrypted information and quantum key used to secure it upon non-local multi-qubit entanglement.

Taking into account the maturity of the current state of the art in the technical field of Quantum Information and Communication (cf. e.g. [15-29]), there is a need to introduce, discuss and apply industrially the novel concepts of quantum security schemes, also related to the security of quantum information itself. Even though these concepts right now find their direct applications in very specialized solutions and experimental systems in recent future it is expected that with proliferation of quantum communication the proposed invention will gain on significance, especially so when fully universal and scallabe quantum computation and communication will become the new reality in the industry. The described herewithin One-Qubit Pad protocol and its generic implementing device is one such proposition that can be applied successfully in the currently available technology, but will realize its full potential when quantum Internet will dominate classical communication and information processing.

### BACKGROUND ART

One hundred years ago, in 1917 Gilbert Vernam (an engineer of AT&T Bell Labs) invented and then patented his additive polyalphabetic stream cipher, known as the Vernam Cipher [30]. Vernam invented and described in his patent a teleprinter encryptor in which a previously prepared key, kept on a paper tape, is combined character by character with the message to encrypt it. In order to decrypt the encrypted information, only the same key must be used, again combined character by character, producing the decrypted message. The combining function that was described in the Vernam's Patent is the XOR operation (exclusive alternative of the Boolean algebra), applied to bits (impulses in the original patent) used to encode the characters in the Baudot code [31] (an early form of binary encoding). While Vernam did not use explicitly the term “XOR” in his technical description of the patent, he implemented that operation in relay logic. The following example is dervied from the description of the Vernam's patent, with XOR procedure replacing original electrically combining function implementing the logic of the teleprinted device operation: the plaintext character is “A”, encoded as “++−−−” in Baudot code, and the key character is “B”, encoded as “+−−++”; when one applies XOR (logic operation returning true only if two inputs are true and false) for plaintext “++−−−” and key “+−−++”, one obtains the code “−+−++” which reads “G” character in Baudot; there is no way to guess that character “G” actually decrypts to character “A”, unless one knows the key used was character “B”; again applying XOR on “G” (“−+−++”) with “B” (“+−−++”) produces the Baudot code “++−−−” which reads the decrypted character “A”. In a modern generalized representation Vernam cipher operates on bits of classical information: either 0 or 1. Any classical information can be encoded binarily as sequences of 0's and 1's, and that is of course the information architecture that great majority of contemporary electronic devices operate within (including computers and networks). Let's consider the following example: A message reading “Hello” is encoded (UTF8) as M=0100100001100101011011000110110001101111 (with 8 bits per character it is 40 bits long). If one uses a random (meaningless) key, e.g. K=1101010110110001011101011101 001000110100, the XOR encrypted message (M XOR K) will read E=1001110111010100000110011011111001011011, which also doesn't have any meaning. If the key is truly random and private, then without it there is no way to compute what was the original message. Only if one has the key K then the encrypted message E can be again XOR'ed bitwise with the key K to return original message M.

Few years after the patent was awarded to Vernam, Joseph Mauborgne (a captain in the US Army Signal Corps) modified Vernam's invention changing the key to random. These two ideas combined, implement what is now famously known as the One-Time Pad (OTP) classical cipher. Only about 20 years later Claude Shannon, also at Bell Labs, proved formally within his now foundational Informations Theory that the One-Time Pad, properly implemented with random key is unbreakable (these proofs were done in 1941 during World War II within Shannon's war research effort, and were published after declassification in 1949 [32]). In the same paper Shannon also proved that any unbreakable (i.e. theoretically secure) system must have essentially the same characteristics as the One-Time Pad: the key must be as long as the message and truly random (which also implies for the key to be never reused in whole or part and kept secret). The US National Security Agency has called Gilbert Vernam's patent that lead to the One-Time Pad concept “perhaps one of the most important in the history of cryptography.” [33]. Since this discovery not much have changed in terms of ground breaking cryptographic ideas. In the 1970s there has been started a shift towards a novel paradigm called asymmetric cryptography (or public-key cryptography), that originated in the proposal of Diffie-Helman protocol [34] to solve the problem of the secure key distribution between the One-Time Pad parties. But the public-key cryptography (generalized from Diffie-Helmann's approach from key distribution to actual encryption and authentication within digital signatures), practical as it is, does not offer the level of unconditional or absolute (i.e. information-theoretic) security—it is fully computationally conditioned. Wheras classical models of computation (based on classical physics laws) do not pose threat to some of mathematical difficult problems (e.g. factorization of large numbers into primes as used e.g. in the RSA scheme [35] or finding discrete logarithms in elliptic curve cryptography used e.g. in ECDSA for Bitcoin [36, 37]), the quantum computation model perfectly does so and both mentioned cryptosystems would be instantly broken if practical quantum computer is construced. In most simple terms in public-key cryptography each sender and receiver has a pair of keys: the private key and the public key. The relation between private and public keys is asymmetric in terms of mathematics, e.g. it is easy to multiply two known prime numbers to obtain one large number, but conversingly it is very difficult (for best known classical algorithms difficulty scales exponentially with increasing input size of the problem) to factorize large number into its two prime factors. In view of these problems (e.g. concerning Bitcoin's susceptibility to quantum computation due to discrete logarithm based elliptic curve cryptography used in its definition) if there is a breakthrough in practical quantum computation then there would be an expected break down in trillions of dollars worth financial market (only the Bitcoin capitalization is currently few hundreds billions dollars), not mentioning much more crucial and strategic implications with public Internet and military proliferation of public-key cryptography). Therefore one can see that propositions of new concepts for quantum information and communication applications based on non-local quantum entanglement [38] in secret storing and communication, with extensions to possible consideration of applications towards e.g. quantum entaglement based currency that could be a hypothetical quantum successor of the classical Bitcoin protocol—are seemingly of certain importance.

### SUMMARY OF INVENTION

The proposed invention is the One-Qubit Pad (OQP) protocol and its generic implementing device.

The protocol enables quantum-information-theoretic secure encryption of the quantum information (quantum message) of n qubits register (M) in unknown arbitrary states with just a single key qubit (K) also in unknown arbitrary quantum superposition upon provision of a multi-qubit entanglement between the single key qubit and the n qubits of the quantum message. The proposed invention's central concept is the use of the quantum controlled negation (CNOT) gate iteratively applying it on the single qubit key (control qubit) and subsequent n qubits of the quantum information (message) to encrypt it. The iterative use of CNOT on the key qubit and qubits of the message will entangle all n+1 qubits (introducing a jointly entangled state), which means that both K′ and M′ together entangled were individually evolving in a non-unitary transformations bringing those states to their mixed quantum configurations. The OQP protocol and the architecture of its implementing generic device are presented in the FIG. 2 and FIG. 3 The original quantum message M cannot be obtained from the encrypted message in M′ without the single qubit K′. To decrypt the quantum message M′ to its original state of M (by disentanglement) one needs to have the qubit K′ and either reverse the protocol (applying CNOT operations in the reversed order) or simply measure the entangled key qubit K′ and then depending on the outcome have either straightforwardly restored the quantum message M from M′ or its quantum negation, i.e. one needs to again quantumly negate all qubits of the message by applying the σₓ pauli matrix controlled by single classical bit being the outcome of the measurement of K′ what is presented in the FIG. 4 (this can be understood as a CNOT with classical control bit of realized upon measurement of the key qubit K′ projection state and the quantum target qubits of all n qubits in the quantum message).

The advantages of the proposed protocol over the state-of-the-art are discussed in detail in the section Advantageous Effects of Invention. One of the most important difference of the OQP versus classical OTP and schemes based on quantum information encryption with classical keys (so called Quantum Private Channels) is that in the latter cases the key can be copied. In OQP the quantum key (K) cannot be copied due to the no-cloning theorem applying in quantum mechanics [39]. In comparison to some discussion of the quantum information encryption with quantum keys, as e.g. in [40], the proposed OQP protocol has an edge in its extreme efficiency, reducing the key to just a single qubit as its name points: One-Qubit Pad. The main application of the protocol and its implementing generic device is to lock the quantum information M with the key K of just a single qubit in order to disallow any potential access to the original n qubits quantum information M by an adversary (e.g. the quantum information M might be some valuable output of quantum computation and it might be considered to be locked from an adversary thus not able to use it as an input in his quantum computation). The less general application of the protocol towards communication is best described in combination with the Quantum Teleportation protocol [41], which without the OQP requires pre-sharing of n pairs of Bell states between Alice and Bob to securely communicate n qubits of quantum message, whereas in contrast with the OQP it requires sharing of just a single Bell state to securely teleport only the single quantum key qubit K′ with sending the encrypted M′ quantum message through insecure local quantum channel. The full discussion of applications (especially related to the communication context in joint operation with Quantum Teleportation is presented in the section Industrial Applicability). Below we present brief formulation of a technical problem the invention is concerned with along with detailed technical description of its solution.

### Technical Problem

The problem for which the proposed invention is a novel solution concerns unconditionally (i.e. information-theoretic) secure encryption of quantum information. The quantum information is fundamentally different from classical information and in general it could be identified with the states of quantum systems (physical systems described by quantum mechanics laws), whereas classical information could be identified with states of classical systems (i.e. physical systems of properties described by classical physics laws). While the classical information (usually encoded as bits) is the subject of classical computation and communication, the quantum information (usually defined as qubits, the quantum analog of classical bits incorporating superposition) is basic notion of quantum computation and communication. The two areas differ significantly. The proposed invention focuses on the domain of purely quantum information and communication and solves the problem of finding the most efficient protocol (and related generic device) to unconditionally securely encrypt quantum information of some significance with a quantum key (a very special one in contrast to the classical case, as sufficiently consisting of only a single qubit to still provide information-theoretic, i.e. unconditional security). The proposed protocol and device are a generalized quantum version of the classical concept known as the One-Time Pad (OTP) and in reference to this 100 years old invention (defined upon the Vernam's cipher) it is called the One-Qubit Pad (OQP), to highlight the main property of this entanglement based quantum information encryption protocol, that it only requires a single qubit key of unknown and private state, to offer unconditional security of n qubits unknown quantum information due to introduction of multi-qubit quantum entanglement.

### Solution to Problem

The novel solution to the above specified problem of quantum information encryption lies in the proposed protocol of the One-Qubit Pad (OQP). The OQP protocol and its implementing generic device define the following basic notions:
1. Alice and Bob are two actors of the protocol or users of the device (in some applications they can be communication sides). In principle the quantum information can also be locked only by Alice to be unlocked later, thus in the meantime remaining secure against adversary (Eve).
2. The quantum information or quantum message M (this is a quantum register of n qubits, each storing certain unknown quantum state either pure or mixed, if these qubits' states are known e.g. upon measurement then M stores classical information—in general case M can be of some meaning to Alice, e.g. constitute an output of a certain complex quantum computation which could be highly valuable).
3. The quantum key K consisting of a single qubit in unknown state (this single qubit is kept well protected—in a straightforwd generalization of the classical OTP to Quantum One-Time Pad, the key K is rather undersoot as a secret register of n qubits also in unknown quantum states, either pure or mixed: if K qubit in OQP or qubits in QOTP are measured then K reduces to the classical information key; the length of K register equal to M is due to straightforward extension of classical One-Time Pad to quantum case herewithin referred to as QOTP where entanglement is only introduced in pairs of corresponding subsequent qubits of K and M; the main aspect of the One-Qubit Pad protocol is to show how the quantum key can be reduced to a single qubit due to utilizing in the invention of multi-qubit entangled states).
4. Eve is the generally the third party understood to be an adversary of Alice and Bob (in general she is interested in obtaining the decrypted quantum message M, and in both storage and communication scenarios of the protocol she wants to access the original quantum information from its encrypted form without the quantum key, which is kept secure from her).

Before we proceed to defining the OQP protocol, lets first consider the trivial extension of the classical One-Time Pad (OTP) to the quantum case, thus discussing the concept (not well defined in the current literature) that can be referred to as the Quantum One-Time Pad QOTP protocol. In most general terms the QOTP will work in the way described below with the following assumption made on the quantum key K register: that it will contain the same number of qubits as the quantum message M it aims to encrypt. Upon the QOTP protocol each qubit of the quantum message register M is processed with corresponding qubit of quantum key register K upon Controlled NOT two-qubits quantum gate (CNOT). The key (K) qubits are control qubits, while the message (M) qubits are target qubits. In classical terms CNOT operation is equivalent to XOR (just leaves the first/controlling input bit as the first/controlling output bit without change, and applies logic negation on the second/target input bit as the output bit if and only if the first/controlling input bit is equal to 1—this is also equivalent to output bit being set as the bit sum modulo 2 of two input bits). In contrast to classical case the quantum generalization of CNOT gate introduces quantum entanglement. For the non-classical both pure and mixed quantum states of M and K the CNOT gate will entangle two corresponding qubits of M and K. Hence if M (and thus K) registers consist of n qubits, then after n-iterations, all the qubits in M will be entangled with corresponding qubits in K. Each corresponding pair of qubits from the original quantum message (M) and the quantum key (K) registers are now entangled. Both registers in new pairwise entangled states we will call by M′ and K′. This means that each corresponding qubit of M′ with the paired (entangled) qubit of K′ are individually in their mixed (non-normalized) states (it should be highlighted that the entanglement involved here is only pairwise—between the individual key qubit and its corresponding upon position message qubit together creating entangled n pairs on those n corresponding positions of both registers). The operation of the QOTP protocol is presented on the FIG. 1.

Now if the entangled key register K′ is kept secret, then the register M′ contains fully quantumly (and non-locally due to entanglement) encrypted quantum message. If not at disposal of the quantum key K′ it is impossible to obtain original quantum message M from M′ (even if one had infinite computational resources). This is guaranteed by quantum mechanics laws. Also the original K and M do not exist anymore (as quantum information they couldn't have been copied) which is also guaranteed by fundamental quantum laws (the no-cloning theorem[39]), which adds up to the fundamental and absolute security of the protocol. It should be stressed that the QOTP quantum encryption protocol encrypts quantum information non-locally (it non-locally stores both the original M and K quantum information between the M′ and K′ qubits registers that are entangled—no individual register stores the information anymore). K′ without M′ is informationless and vice-vera. The quantum information has been non-locally hidden in both registers.

One may ask how exactly the above described quantum generalization of classical OTP—referred herewithin as the QOTP is related to the original One-Time Pad (OTP) proposed initially as Vernam's cipher and then refined by Mauborgne to use random keys (proven information-theoretic, i.e. unconditionally secure by Shannon in 1940s). In fact the much more general QOTP can be easily reduced to classical OTP in case if both qubits of K and M reside only in a given Hilbert basis states (e.g. both are states of the computational basis {|0 [symbol] , |1 [symbol] })). This reduction will lose however the crucial in the quantum information case non-locality aspect. In this situation (of basis states in both K and M, actually representing classical information) the quantum CNOT gate will act as purely classical CNOT gate and thus as classical Boolean logic XOR operation exactly like in the OTP. Yet if the key qubits K are not in basis states (classical information), but rather their superpositions (quantum information), then the CNOT will inevitable introduce quantum entanglement between corresponding qubits of M and K, generalizing the scheme to QOTP (even if register M consists of qubits in basis states, i.e. classical information).

What however is fully detached from classical domain is the new concept that we will call the One-Qubit Pad (OQP).

This scheme, presented in its principle in the FIG. 2, will allow the use for perfectly locking (quantum encrypting within non-local entanglement) of quantum information (quantum message) of n-qubits register (M) just a single qubit (one qubit) key K. In the protocol of OQP we will have same definitions and same processing of message M and key K as in QOTP instead of one crucial change: now the quantum key K is containing only one qubit, and the protocol will now process sequentially each qubit of register M with this single qubit of K upon CNOT quantum gate (again the single key qubit K will always be a control qubit in CNOT, while subsequent qubits of quantum message M will be target qubits of the CNOT). Upon the first iteration the qubit K will entangle with first qubit of M. In second iteration when qubit K is in CNOT with the second qubit of M, the resulting state will be entanglement between the qubit K and two qubits of M). In n-th iteration of the qubit K in CNOT with the last qubit of M the result will be fully entangled n+1 state (all qubits of K and M will be entangled together).

After the OQP entangling encryption again the message register M is in new state M′ (entangled alltogether with the new state of key K′). If the key K′ is hidden, then there is no way to extract original quantum information from M′ guaranteed by quantum mechanics laws. Additionally same laws guarantee that there cannot exist a copy of original quantum message (M) and neither of the key (K) (which is due to no-cloning theorem). Therefore the OQP similarly as discussed above QOTP is absolutely secure even in contrast to classical OTP which is absolutely secure only under the assumption that the used classical key had not beed copied (or conversingly the classical message being encrypted had not beed copied before encryption)—because in classical physics there are no laws that would disallow such situation. In principle even after encryption in classical OTP the original message can be found and copied (even if it is deleted this deletion is doomed to be imperfect and sufficiently advanced technology could be used to determine the classical message M, e.g. by very detailed analysis of the radiation resulting to classical storing and processing on macroscopic physical carriers of the message M). Such hypothetical situation is however fully ruled out on the fundamental level by the laws of quantum mechanics in the QOTP and OQP protocols. However the result of OQP is of a fundamental significance. It means that information capacity of a single qubit K′ can in fact encode (however non-locally in quantum entanglement with M′) the information from n-qubits sequence M (along with original information on single qubit key K), even if n is infinite (but still it is discrete, then the cardinal number is N₀). It is not surprising as the informational capacity of each single qubit is continuously infinite, i.e. infinite in terms of continuous cardinal number c.

Now to decrypt (disentangle) the quantum message M from M′ using key K′ one needs to revert the process: using the same quantum CNOT gate, one needs to process the qubit K′ with each subsequent qubit from register M′ but in the reversed order: in the first step the key qubit K′ will be in CNOT gate with the last qubit from M′ (this will disentangle the last qubit in M′ and return it to original state of the last qubit in M register), then again the key qubit will need to be in CNOT gate with the one before last of M′ qubits (the result will be two disentangled last qubits of M′ now in their original states as they had in M register). This procedure iterated n times will eventually lead in the last step to finally the key qubit being under CNOT operation with the first qubit of M′, and after this the disentanglement of M′ with K′ will be complete, the quantum message register will now be fully in the original state as it was in M register, and also the key qubit will return to its original state as in K). The applications scenarios of OQP device are more communication-friendly than of QOTP, which will be discussed in the Industrial Applicability chapter below.

The technical description of the generic device implementing the proposed OQP protocol (One-Qubit Pad) is following.

Let us first assume that we have a single qubit key K in the state |K [symbol] =a|0 [symbol] +b|1 [symbol] (this a private or secret quantum information of only one qubit, that we will use to quantum-information-theoretically secure quantum information of any arbitrary number of qubits). The device implementing the OQP protocol is referred to as any generic device implementing qubits. The invention thus is regarding the technical device that works as specified along the below technical description, however particularities of many possible implementations of qubits and quantum controlled negation (CNOT) operations on them (including the implementations currently realized technologically and the implementations yet to be realized in future with advancement of the technology) are all covered by the proposed device (it doesn't matter for the invention how particularly the qubit or the CNOT gate will be implemented, all current and future implementations of these two fundamental notions are not conditioning the OQP protocol generic device upon its below operation description on the way the qubits are processed with arrangement upon CNOT operations). For now, as a simplification, we can assume that the key qubit K is in a pure state (i.e. |a|²+|b|²=1). One can ascertain upon more general analysis that it doesn't matter whether the key or the message qubits are in pure or mixed states before the encryption (as all operations are unitary, with exception of the key qubit K′ measurement, which however can be replaced by reversed CNOTs).

Let's then assume we have some important quantum information (quantum message) contained within n-qubits register M (again for simplicity these message qubits are in pure states, what can be easily generalized to mixed states if the states of M share entanglement either with themselves or also externally with some other qubits—this doesn't change anything in the OQP protocol). What this quantum information can represent is discussed within the section regarding applications (it can be e.g. some result of important quantum computation, a secret quantum message or even quantum entanglement currency wallet, etc., i.e. any valuable quantum information).

To illustrate operation of the OQP protocol we will limit the number of qubits in M register to 3, thus |M [symbol] =(C|0 [symbol] +d|1 [symbol] )(e|0 [symbol] +f|1 [symbol] )(g|0 [symbol] +h|1 [symbol] )=|ψ₁ [symbol] . The density matrix of M is

$${ρ}_{M} = {ρ}_{{ψ}_{1}} = \vert {ψ}_{1} 〉 〈 {ψ}_{1} \vert = ( c \vert 0 〉 + d \vert 1 〉 ) ( e \vert 0 〉 + f \vert 1 〉 ) ( g \vert 0 〉 + h \vert 1 〉 ) ( {c}^{*} 〈 0 \vert + {d}^{*} 〈 1 \vert ) ( {e}^{*} 〈 0 \vert + {f}^{*} 〈 1 \vert ) ( {g}^{*} 〈 0 \vert + {h}^{*} 〈 1 \vert ) . \qquad ( 1 )$$

The CNOT gate used in the OQP protocol is a well known notion in quantum information processing [42]. The implementation of the CNOT (similarly as of qubits) doesn't play any role for the OQP generic device (it is how those qubits are processed upon arrangement of entangling CNOT operations). The CNOT quantum circuits logical operation represents a 2-qubits gate of controlled quantum negation. It is a generalization of the classical CNOT gate (a 2-bits gate generalizing the Boolean algebra gate called the exclusive alternative XOR to a reversible case). The quantum CNOT gate acting on classical information (or the basis states of the qubit definition) is essentially reducing to standard classical CNOT, implementing on the target bit a sum with control bit modulo 2 (the rest of division by 2) which is also fully equivalent to XOR logical operation (while control bit is left unchanged and outputted for reversibility). For quantum information (qubits in superpositions of the qubit definition basis 10) and 11)) the quantum CNOT introduces entanglement (it is representing a unitary evolution on both qubits together which takes however their state out of separable in regard to tensor product form to a non-separable one which is called entangled, and thus it implements a non-unitary evolution on each of the individual qubits taking their individual states from pure to mixed, or if they were already mixed on their own, entangled with some other qubits, it additionally entangles them together as well). The quantum CNOT gate represents a controlled operation of quantum negation, which itself is a single qubit gate also named Pauli matrix X, or σₓ.

The cyclic operation of the CNOT gate controlled by the key qubit′ and targeting subsequent qubits of quantum message register M will have the following effect:

After the first iteration we have:

(a(0 [symbol] +b|1 [symbol] )CNOT(c|0 [symbol] +d|1 [symbol] )=(ac|00 [symbol] +ad|01 [symbol] +bc|11 [symbol] +bd|10 [symbol] ) (2)

((26)) This is now an unseparable 4-terms entangled state of two qubits (key qubit K′ and first qubit of M′ register).

After the second iteration:

(ac|00 [symbol] +ad|01 [symbol] +bc|11 [symbol] +bd|10 [symbol] )CNOT(e|0 [symbol] +f|1 [symbol] )=(ace|000 [symbol] +acf|001 [symbol] +ade|010 [symbol] +adf|011 [symbol] +bce|111 [symbol] +bcf|110 [symbol] +bde|101 [symbol] +bdf|100 [symbol] ) (3)

The second iteration has produced an unseparable 8-terms entangled state of 3 qubits (key qubit K and two first qubits of M). One should note only the first qubit—the key qubit K—is conditioning the CNOT gate applied in this iteration to the third qubit, i.e. the second of the quantum message register M.

Then, the third iteration produces the following state:

(ace|000 [symbol] +acf|001 [symbol] +ade|010 [symbol] +adf|011 [symbol] +bce|111 [symbol] +bcf|110 [symbol] +bde|101 [symbol] +bdf|100 [symbol] )CNOT(g|0 [symbol] +h|1 [symbol] )=(aceg|0000 [symbol] +aceh|0001 [symbol] +acfg|0010 [symbol] +acfh|0011 [symbol] +adeg|0100 [symbol] +adeh|0101 [symbol] +adfg|0110 [symbol] +adfh|0111 [symbol] +bceg|1111 [symbol] +bceh|1110 [symbol] +bcfg|1101 [symbol] +bcfh|1100 [symbol] +bdeg|1011 [symbol] +bdeh|1010 [symbol] +bdfg|1001 [symbol] +bdfh|1000 [symbol] ) (4)

This is now unseparable 16-terms entangled state of 4 qubits (key qubit K and three qubits of M register). Again only the first qubit—the key qubit K—is conditioning the CNOT gate applied now to the fourth qubit, i.e. the third in the quantum message register M. If the quantum message M has more than 3 qubits then subsequent iterations (up to n-th iteration) would be analogous to the above.

After the above described iterations the quantum message M has been non-locally encrypted (locked) within a multiple entanglement with just the single key qubit K. Now both K and M have transformed to K′ and M′ in a jointly entangled pure state, that we could call Z′ (separately both K′ and M′ are in their mixed states). If the key qubit K′ is to be hidden and kept secret one may consider what is the mixed state of the M′. Let's consider simplified example of 3 qubits quantum message M, now in mixed state M′ (entangled with qubit K′). Naive writing down of the vector state of M′ would have the following form (one must note however that this is not a pure state anymore, it is not normalized and thus the vector states formalism falls short to be used in representing of the mixed states and one must resort to the density matrix formalism):

A naively (and not correctly) written vector state form of the unnormalized mixed state M′ is following:

(ceg|000 [symbol] +ceh|001 [symbol] +cfg|010 [symbol] +cfh|011 [symbol] +deg|100 [symbol] +deh|101 [symbol] +dfg|110 [symbol] +dfh|111 [symbol] +ceg|111 [symbol] +ceh|110 [symbol] +cfg|101 [symbol] +cfh|100 [symbol] +deg|011 [symbol] +deh|010 [symbol] +dfg|001 [symbol] +dfh|000 [symbol] ). (5)

Now correctly the same mixed state M′ expressed in the form of the reduced density matrix after tracing out the state of the key qubit K′ will constitute a mixture with probabilities |a|² and |b|² (determined by the original state of the secret key qubit K) of projection operators (which are also pure density matrices) upon the following two pure states with the probabilities:

|a|²: ceg|000 [symbol] +ceh|001 [symbol] +cfg|010 [symbol] +cfh|011 [symbol] +deg|100 [symbol] +deh|101 [symbol] +dfg|110 [symbol] +dfh|111 [symbol] =|ψ₁

[symbol]

|b|²: ceg|111 [symbol] +ceh|110 [symbol] +cfg|101 [symbol] +cfh|100 [symbol] +deg|011 [symbol] +deh|010 [symbol] +dfg|001 [symbol] +dfh|000 [symbol] =|ψ₂

[symbol]

This is equivalent with writing down the reduced density matrix of the mixed state of M′ as:

$${ρ}_{{M}^{′}} = {Tr}_{{K}^{′}} ( {ρ}_{{Z}^{′}} ) = 〈 0 \vert {ρ}_{{Z}^{′}} \vert 0 〉 + 〈 1 \vert {ρ}_{{Z}^{′}} \vert 1 〉 = {\vert a \vert}^{2} \vert {ψ}_{1} 〉 〈 {ψ}_{1} \vert + {\vert b \vert}^{2} \vert {ψ}_{2} 〉 〈 {ψ}_{2} \vert = {\vert a \vert}^{2} {P}_{{ψ}_{1}} + {\vert b \vert}^{2} {P}_{{ψ}_{2}} = {\vert a \vert}^{2} {ρ}_{{ψ}_{1}} + {\vert b \vert}^{2} {ρ}_{{ψ}_{2}} = {\vert a \vert}^{2} {ρ}_{M} + {\vert b \vert}^{2} {σ}_{x}^{{⊗}^{n}} {ρ}_{M} {σ}_{x}^{{⊗}^{n}} \qquad ( 6 )$$

Note that trace was over the first qubit (key). Of course the above two pure states are not any separate states in current situation (i.e. the qubit key K′ has not been measured and is kept hidden in secret). The state of M′ is now correctly described by the operator of reduced density matrix that has a spectral decomposition on |a|² P_{ψ}_{₁}+|b|² P_{ψ}_{₂} (where P_{ψ}_{₁} and P_{ψ}_{₂} are projection operators on the pure states |ψ₁)=|M [symbol] and |ψ₂ [symbol] =σₓ^{⊗}^{ⁿ}|M [symbol] ).

Performing measurement on the 3-qubits of M′ or performing any other unitary operation (change of basis) on them without knowledge of the key qubit K will not help in any way to restore the original M quantum information. For instance performing measurement of 3 qubits in M′ in the computational basis {|0 [symbol] ,|1 [symbol] } will first realize the probability of choice of the pure state of 3 qubits in M′ (either |a|² for |ψ₁ [symbol] or |b|² for |ψ₂ [symbol] ) then multiply it with one of the probabilities made up of multiplications of square of moduluses of corresponding to the projected state 3 of 6 linear combination complex coefficients: c de f g h. E.g. if one will project the 3 qubits in M′ to state |000 [symbol] it could have happened only with probability equal to |a|²|c|²|e²|g|² or |b|²|d|²|f²|h|². Naturally if these coefficients are unknown (this is after all the unknown content of the original quantum information or quantum message M) to someone making the measurement it is impossible to infer anything about them upon the measurement outcome. In a hypothetical assumption of having at disposal a large set of copies of the state encrypted by entanglement quantum message register M′, it would be possible to deduce some information about these coefficients after large number of measurements, however due to fundamental law in quantum mechanics (the no-cloning theorem [39]) the register M′ cannot be copied just as any other quantum information (it contains unknown quantum states). Moreover the bigger number of qubits in register M′ the harder it would be to deduce information about coefficients and this difficulty will grow exponentially, due to unknown linear combination coefficients in M′ and exponentially growing their number in superposition with the dimension of the Hilbert space 2ⁿ, even if one assumes to have the copies of M′ (which could be argued for in the case that qubits in M would originally be in some standard states e.g. |0 [symbol] and |1 [symbol] which however represent classical information, or in their maximally non-orthogonal superpositions |+ [symbol] and |− [symbol] − the introduced symmetries could then allow even for disentanglement upon special maximally non-orthogonal change of basis).

Upon the above discussion there is revealed one of the most important properties of the OQP protocol, namely the property of the single key qubit K′ measurement. If someone performs the measurement on the key qubit K′, then he will non-locally project with probability |a|² the 3-qubits state in M′ to |ψ₁ [symbol] pure state or with probability |b|² to |ψ₂ [symbol] pure state each of the above two alternative pure states to which M′ will be projected upon measurement of the key qubit K′ are not entangled anymore (this means measurement of the key qubit K′ will disentangle M′, thus returning it to the original quantum message M, or essentially decrypting it) but within the following two cases:
with probability |a|²: ceg|000 [symbol] +ceh|001 [symbol] +cfg|010 [symbol] +cfh|011 [symbol] +deg|100 [symbol] +deh|101 [symbol] +dfg|110 [symbol] +dfh|111 [symbol] =|ψ₁ [symbol] =(c|0 [symbol] +d|1 [symbol] )(e|0 [symbol] +f|1 [symbol] )(g|0 [symbol] +h|1 [symbol] )—this state is shown explicitly to be separable not entangled states of the 3 original qubits of quantum message M,
with probability |b|²: ceg|111 [symbol] +ceh|110 [symbol] +cfg|101 [symbol] +cfh|100 [symbol] +deg|011 [symbol] +deh|010 [symbol] +dfg|001 [symbol] +dfh|000 [symbol] =|ψ₂ [symbol] =(c|1 [symbol] +d|0 [symbol] )(e|1 [symbol] +f|0 [symbol] )(g|1 [symbol] +h|0 [symbol] )—this state is shown to be also separable not entangled states of the 3 qubits, but they are all quantum negated (Pauli σₓ transformation) qubits of M.

To make sure this is the case one can follow below analysis in the density matrix formalism in simplified case of only 2 qubits: 1 key qubit |K [symbol] =a|0 [symbol] +|1 [symbol] and 1 message qubit |M [symbol] =c |0 [symbol] +d|1 [symbol] (the case for 3 qubits as discussed above easily generalizes the density matrix formalism analysis below, however due to number of terms in density matrix equal to 64 instead of 16 it is too robust to be presented here).

The CNOT operation on both qubits (K is control qubit and M is target qubit) gives: (a|0)+b|1 [symbol] ) CNOT (c|0 [symbol] +d|1 [symbol] )=ac|00 [symbol] +ad|01 [symbol] +bc|11 [symbol] +bd|10 [symbol] .

The density matrix of the resulting entangled state of key qubit (K′) and message qubit (M′) is following:

ac|00 [symbol] +ad|01 [symbol] +bc|11 [symbol] +bd|10 [symbol] *a*c* [symbol] 00|+a*d* [symbol] 01|+b*c* [symbol] 11|+b*d* [symbol] 10|=aca*c*|00 [symbol] [symbol] 00|+ace d*|00 [symbol] [symbol] 01|+acb*c*|00 [symbol] [symbol] 11|+acb*d*|00 [symbol] [symbol] 10|+ada*c*|01 [symbol] [symbol] 00|+ada*d*|01 [symbol] [symbol] 01|+adb*c*|01 [symbol] [symbol] 11|+adb*d*|01 [symbol] [symbol] 10|+bca*c*|11 [symbol] [symbol] 00|+bca*d*|11 [symbol] [symbol] 01|+bcb*c*|11 [symbol] [symbol] 11|+bcb*d*|11 [symbol] [symbol] 10|+bda*c*|10 [symbol] [symbol] 00|+bda*d*|10 [symbol] [symbol] 01|+bdb*c*|10 [symbol] [symbol] 11|+bdb*d*|10 [symbol] [symbol] 10| (7)

Hence the form of density matrix of the mixed state of message qubit (M′) after tracing out key qubit K′:

|a|²|c|²|0 [symbol] [symbol] 0|+|a|²cd*|0 [symbol] [symbol] 1|+|a|²dc*|1 [symbol] [symbol] 0|+|a|²|d|²|1 [symbol] [symbol] 1|+|b|²|c|²|1 [symbol] [symbol] 1|+|b|²cd*|1 [symbol] [symbol] 0|+|b|²dc*|0 [symbol] [symbol] 1|+|b|²|d|²|0 [symbol] [symbol] 0| (8)

From this form it is evident that if the key qubit (K) is measured then with the probabilities:
   |a|²: the message qubit reduced density matrix has the form: |c|²|0 [symbol] [symbol] 0|+cd*|0 [symbol] [symbol] 1|+dc*|1 [symbol] [symbol] 0|+|d|²|1 [symbol] [symbol] 1|=(c|0 [symbol] +d|1 [symbol] )(c* [symbol] 0|+d* [symbol] 1|)—this is projection operator on state (c|0 [symbol] +d|1 [symbol] ) which means that after measuring qubit K the qubit M returns to its original pure state,
   |b|²: the message qubit reduced density matrix has the form: |c|²|1 [symbol] [symbol] 1|+cd*|1 [symbol] [symbol] 0|+dc*|0 [symbol] [symbol] 1|+|d|²|0 [symbol] [symbol] 0|=(c|1 [symbol] +d|0 [symbol] ))(c* [symbol] 1|+d* [symbol] 0|))—this is projection operator on state (c|1 [symbol] +d|0 [symbol] ) which means that after measuring qubit K the qubit M returns to the quantum negation of its original pure state (so if one measures the key qubit as 1 [symbol] one knows that to restore original state of qubit in M it must be quantum negated).

This means that measurement on the key qubit K′ instantly (non-locally) decrypts the entangled M′ to disentangled M (while in the case of projecting the key qubit K′ upon its measurement to state |0 [symbol] with probability |a|² the M′ is in no time, instantly, projected to M, however in the opposite case with probability |b|² the key qubit K′ upon measurement projects to |1 [symbol] , which will mean that each qubit in the register M must be quantum negated, i.e. under action of Pauli σₓ transformation, what effectively restores original quantum information M. Another decrypting (disentangling) procedure to obtain original quantum message M (also only possible with the key qubit K′), is to reverse all unitary operations by applying those very operations in a reversed order (all unitary operations are reversible, but the ones used here, i.e. quantum negation σₓ and more generally CNOT transformation are all self-reversible, which means if applied twice, they reduce to identity transformations). Therefore to this end of decrypting M′ one needs to cyclically transform the key qubit K′ (as the control qubit) with subsequent qubits in M′ (target qubits) but in a reversed order (first the K′ qubit CNOT with last M′ qubit, second the K′ qubit CNOT with one before the last qubit of M′, and finally in n-th iteration the K′ qubit CNOT with the first qubit of M′). This will revert all unitary operations and thus disentagle the state of the single qubit key K′ with quantum message register M′, setting both states in their original configurations of K and M and decrypting the original quantum information (even if the key qubit K′ was in mixed state before encryption).

This ends technical description within the formalism of quantum information of the OQP protocol and its implementing generic device. Applications of the protocol are discussed in the Industrial Applicability section below.

Here some comments may apply regarding the puzzling on a first glance result, that one can use just one qubit (key K) to unconditionally (quantum information theoretic) lock arbitrarily long sequence of n qubits (in register M). In other words is it possible to explain how comes ability to store the information in the form of entanglement with infinitely many (n) qubits of quantum message M just in the single key qubit K. One should notice that qubit information capacity is continuously infinite (due to linear combination coefficients being two complex numbers from the continuous domain, which is due to defining quantum mechanics systems' spaces of states as Hilbert spaces upon the field of complex numbers). Therefore the discrete infinity (infinite number of qubits n with cardinal number N₀) is virtually nothing in comparison to continuous infinity of the information capacity of just a single qubit. However it should be stressed that actually the information is non-locally stored in the phase of all n+1 qubits (the phaze is thus non-local and is due to the special non-separable entangled forms of multiplications of the involved superposition coefficients between all the qubits), which means that the essential entanglement information is also sharingly stored within M′. However it is true that this information is stored non-locally. If one only has the single qubit key K′, one can by just measuring it decrypt the M′ to M (by disentangling it), wherever it is located (and this will happen instantly, or even retrocausally in more general interpretation involving time related entanglement experiments, as a result of the projection based quantum measurement). It will however require to transfer 1 bit of the classical information (upmost with velocity of light) to the location of the decrypted M that will tell the receiver of M, whether or not it is in the original or quantum negated configuration, thus for it to be correctly recovered).

The result of the proposed OQP protocol generic device can be discussed upon a topological approach. In a simplified and illustrative analogy the entanglement is related to phase changes upon encircling one particle by the other with virtual loops that entangle particles together. In limited dimensions of phase spaces such as would apply to qubits this could be interpreted in terms of non-reducible loops of trajectories with one qubit around the other. Each abstractly-modelled in topological sense loop of entanglement (corresponding to action of each CNOT cycle) of the key qubit K around subsequent qubits of the quantum message M is entangling M′ qubits together and all of them with K′. This will produce a joint knot of entanglement between all the qubits, however characterized by a certain symmetry in relation to the key qubit K. Each such abstract loop (CNOT) is effectively changing the phase and will result finally in the non-local phase entanglement for all n+1 qubits. Upon density matrix strict and formal consideration this can be seen in detail. All the entangling phases terms due to phase representation of complex linear combination coefficients for each qubit superposition (the Bloch sphere representation) occupy non-diagonal elements in the density matrix of the whole n+1 qubits system. Due to special symmetry in relation to the qubit K′ only the measurement done over the qubit key K′ will dephase the density matrix in such a manner that will result in a separable in regard to tensor product pure states density matrices for M′ qubits and thus will be equivalent with disentangling of the whole M′ qubits register from the qubit key K′. This means that entangling phase of the whole system can be freed by measuring the key qubit K′, what in the topological terms can be interpreted as cutting in such a way that frees all the loops entangling remaining qubits (as these loops, also referred as to topological rings, will be cut at the ring of the K′ entanglement all other rings representing remaining qubits will disentangle, however cutting any other ring which means measuring of any other qubit from M′ will just disentangle this only one qubit—with losing its original state—and leave all others qubits still entangled). In a lousy illustrative comparison one could say that the key qubit K′ is the ring holding other small keys together (each of these small keys is illustrative analog of the respective original qubit from M only when all are disentangled from the main ring of K′ qubit). If K′ is hidden so are effectively all qubits from M upon joint entangled in M′ and M′. The difference to classical analogy is non-locality, which could be visualized in this simplified analogy in the situation that one would be able to still hide only the large ring of individual keys in a pocket without the keys themselves, leaving them however useless on the table. Only if one cuts the K′ ring in the pocket the non-locally bound keys on the table will be freed and will become original quantum information qubits' states. Any manipulation on individual qubits on the table will not reveal original quantum message M without the key ring K′. A more advanced discussion of the relation between quantum physics and topology can be found in e.g. [43-45] where the presented invention authors have also formulated their own contributions to the scientific understanding of the links between the two domains in particular in context of braid groups enabling a geometrical explanation of quantum statistics, i.e. distinction of fermions and bosons in 3D by topological differences in trajectories for elementary particles quantum states replacements, as well as to the concept of anyons [46] in 2D physical systems and discussion of the QHE (Quantum Hall Effect) in topological terms.

### Advantageous Effects of Invention

The main advantage of the proposed invention of the OQP protocol and its generic implementing device is that it uses only a single qubit as the one-qubit key to unconditionally (in quantum information-theoretic sense) secure the n-qubits quantum information (quantum message) encrypted with this one-qubit key. At the basis of the invention is a novel concept not previously described in the literature that very drastically improves efficiency of quantum information encryption due to the non-local quantum entanglement that can be not only used (as discussed previously, e.g. in [40]) pairwise between the subsequent qubits' positions of the key in n-qubits register (or even 2n-qubits splitted in two n-qubits keys registers as proposed in [40]) and the quantum information (message) in also n-qubits register (thus forming pairwise key-qubit and message-qubit entanglements), but rather much more generally utilizing the multi-qubit encryption of then only required just unknown and secret single-qubit key, sequentially co-entangled with qubits of the n-qubits quantum message to be encrypted. This concept provides a qualitative gain: a single (unknown and arbitraty) qubit constituting a key entangled but upon a complex multi-qubit entanglement with the n qubits of the quantum information can secure this quantum information just as well as n (or in some propositions 2n) qubits of the key. It could be discussed how this difference affects security of quantum communication in for example a general scheme of quantum teleportation. Generally in standard quantum teleportation one needs n pairs of maximally entangled qubits (Bell states—together 2n qubits pairwise entangled) to securely and non-locally communicate quantum information of n-qubits. With the OQP protocol there is need for just a single Bell state shared between the parties to teleport securely and non-loelly the single key qubit for the encrypted by multi-qubit entanglement message that is transmitted in the local quantum channel (without pre-shared entanglement). This is however in detail discussed in the Industrial Applicability section below. The list of advantageous effects of invention is also stipulated in a point by point form within the section of Claims.

It should be noted that some publications in the literature interestingly point to discussing the reasons and motivations behind encryption of quantum information. E.g. in [47] it is pointed out that quantum information is already encrypted, as only one bit of information can be revealed from a qubit—but of course the statement that quantum information is by itself encrypted may be considered valid only in the context of classical information. In the context of quantum information, the non-encrypted quantum information can be of course straightforwardly accessed by an adversary not necessarily upon a measurement but more likely e.g. as an input for quantum computation (or more generally quantum information processing). If one would like to secure quantum information of some value from this kind of unauthorized access, the encryption of quantum information is thus necessary. But how to encrypt quantum information? Generally there are two ways to do it: one can either consider some ceretely parameterized unitary or non non-unitary evolution of quantum states, while the latter is due to a unitary evolution of a complex system containing the quantum state in question as a subsystem. Due to the formulation of quantum mechanics of complex systems involving tensor products of Hilbert spaces of their subsystems and the algebraic structure of the tensor product it follows that if complex system evolves unitarily, then its constituting linear combination become non-separable in terms of basis states of subsystems' of Hilbert spaces and thus those subsystems in general do not undergo unitary evolution but are instead non-unitarily transformed from normalized pure states to non-normalized mixed states. In the language of quantum circuits the two mentioned above ways of encrypting quantum information can be realized as quantum gates, controlled by either classical or quantum information. If controlled gates and for clarity let's assume the CNOT gates (the most simple ones and also universal together with one-qubit gates of Hadamard and Phase) are conditioned by classical information they do not introduce entanglement on quantum information (and thus implement the former method of encryption of quantum information—the unitary one without entanglement, in case of CNOT simply the quantum negation Pauli σₓ transformation upon the target qubit). If however they are conditioned by quantum information (superposition of basis states) then they entangle the control qubit with the target qubit (setting them in non separable in regard to tensor product pure state of complex system consisting of two qubits) which means, that they bring the target qubit out of its normalized pure state to non-normalized mixed state upon non-unitary evolution (what can be described correctly within the density matrix formalism). So summarizing the encryption of the quantum information can be done either by some secret parametrizing of the unitary evolution (classically controlled quantum gates) in which case the key (condition of controlled quantum gates) is classical information or by a secret parametrizing of the non-unitary evolution (quantumly controlled quantum gates) where in this case the key for encryption is quantum information inevitable introducing entanglement. It should be noted that the former method is just a special case of the latter one. Therefore for the most general consideration of quantum information encryption, the encryption with a quantum key and entanglement is the most general consideration (which also has one fundamental advantage over the former case of classical information based encryption of quantum states: the quantum key cannot be copied as guaranteed by the no-cloning theorem [39]).

The Solution to Problem section above had in detail explained and illustrated relation of the OQP to QOTP (the Quantum One-Time Pad being straightforward extension of the classical One-Time Pad) (compare FIG. 1 with FIG. 2 and FIG. 3) and the advantages of the former over the latter. It should be noted here that in the literature the Quantum One Time Pad has not been widely discussed. Even though the “quantum one time pad” has been used in previous scientific publications it did not refer not only to the invention presented herewithin (the One-Qubit Pad protocol) but even to the trivial extension of the classical One-Time Pad to quantum case as discussed in the above section. The reference to Quantum One-Time Pad in known scientific literature was applied to a spectrum of different concepts within quantum information with overlaps with the classical information. In most cases described in the scientific literature the QOTP was used to refer to few different methods of quantumly securing communication of classical messages (most prominently this was addressed to the original Quantum Superdense Coding protocol by Bennett, et al. [48] or the QSDC, sometimes also referred to as Quantum Secure Direct Communication). These examples of literature include [49-53]. Also in the context of QOTP in the literature there have been discussed proposals regarding private communication (or also authentication) of quantum information but using only classical information (classical keys composed not of qubits but rather of classical bits). This approach has been for example discussed in [47, 54-56]. Those propositions and discussions can be generalized to the concept of the Private Quantum Channel (PQC) as introduced in [54], but the PQC for encrypting quantum information is based upon classical keys (and thus employing only unitary operations without introducing additional entanglement). Interesting is discussion presented in e.g. [47] as it builds on the concept of recycling of the key, which of the first glance might seem close to the proposed OQP protocol. However it is not the case as the recycling of the key as discussed in this publication refers to the classical key and secondly is certainly very far from the limit of just 1 bit as would be the classical counterpart of the OQP protocol described herewithin.

Summarizing, the currently known in the literature concepts upon quantum information encryption resolve mainly to more fundamental concepts of the Superdense Coding (QSDC) [48], that can be assigned also different acronym expansion: Quantum Secure Direct Communication (which applies to securing classical information with quantum resources—in QSDC Alice and Bob share one copy of Bell state, e.g. −psi+¿. and Alice can send 2 classical bits to Bob by applying controlled σ_{z} and controlled σ_{z} operations to her Bell pair qubit and then send the qubit to Bob, who can determine the 2 bits of classical information by a Bell basis measurement on both qubits, thus the classical information is sent securely and non-locally encoded upon the entanglement) as well as to the Quantum Teleportation (QT) [41], addressing problem of secure communication of quantum information non-locally with both classical and quantum resources (with condition to pre-share n pairs of maximally entangled qubits in Bell states to securely communicate n qubits of quantum information), with the addition of the Private Quantum Channel PQC [54], referring to encrypting of quantum states with classical information and relating this issue with a more general problem of randomization of the quantum state. In one proposition referring to the quantum version of the Vernam cipher in [40] there is introduced generalized PQC approach with quantum key, however consisting of 2n entangled pairs (2n Bell states or ebits as referred to units of maximal entangled pairs) required to encrypt n qubits quantum message. This proposal differs from the herewithin described protocol by using as a key not the unknown quantum information (unknown, arbitraty state of qubit) but rather entanglement itself upon perfectly known quantum states. These states within the key are fully symmetrical maximal entanglement paired (2-qubits) states of the known Bell states, known also to a potential adversary (measured in ebits as used by authors). This is fundamental difference. Defining known Bell states as the key is one of special cases of the QOTP as discussed in the section above and is rather pointing towards a more general protocol of Quantum Teleportation. Moreover it also generalizes the PQC notion from [54], however it doesn't relate to the more general QOTP and OQP protocols. First in our proposition the entanglement in encryption scheme is not a key itself (the key is a quantum state both in straightforward generalization of classical OTP to QOTP and in the novel OQP invention, but in contrast to the discussed in [40] variation of the quantum Vernam chipher—in our more extended generalization of what we understand as a quantum key in both generalized Vernam cipher or QOTP and OQP—the unknown one and therefore certainly not symmetrical). To better contextualize the proposed OQP invention—in up-to-date literature regarding quantum analogs of OTP (or Vernam cipher), the quantum information (message) in the register is encrypted by either classical information or the entanglement key in known quantum state of Bell basis (shared between Alice and Bob) and additionally it is done bitwise, i.e. on each position of the quantum message M using subsequent blocks of the quantum key K with double the number of qubits (to securely send the n qubits quantum information a one qubit protocol is applied bitwise using for each encrypted qubit two Bell states or two ebits). In terms of pointing out advantages of the proposed OQP protocol, this kind of known from the literature proposition [40] may be criqued by the lack of reasonable motivation, in view that OQP can secure quantum information with just a single qubit (and send it securely between communication parties by pre-shared single Bell state, as one can refer to the FIG. 5) whereas in the proposal of [40] the quantum analog of Vernam cipher can securely transmit n qubits of quantum message M by use of the entanglement key consisting of 2n ebits (i.e. Alice and Bob sharing 2n pairs of maximally entangled qubits). Such prerequisite seems to be quite non-efficient, because there are well known means to do it much more efficiently even without the OQP protocol—by the use of Quantum Teleportation (QT). It should be stressed that upon a fundamental approach the more efficient and also more evident generalization of the classical One-Time Pad (Vernam cipher) to the quantum regime in case of meeting prerequisite of sharing n Bell states between the communication parties is the Quantum Teleportation protocol [41] (in QT only one ebit, i.e. one shared Bell state is required to securely transmit one qubit in any arbitrary quantum state, what is sufficient to securely and non-locally transfer the single key qubit in OQP).

Discussing the quantum information in general will fast point to one important aspect: namely that each unknown quantum state of qubit posseses continuous classical information capacity and this fact is of a fundamental importance that exceeds all classical results upon analyses how one can use classical information as keys to encrypt quantum information. In some of the mentioned above literature this concept is shortly discussed but not used as the central aspect of provided security in quantum information encryption. The proposed protocol is fully based on this property of quantum information (the continuously infinite informational capacity of a single qubit). In the OQP protocol an unknown arbitraty quantum state of a single qubit can be effectively used to fully securely encrypt arbitrary quantum message. This result stands out from discussion currently known from the literature. This discussion however applies also to the proposed protocol or more straightforward generalization of the OTP towards QOTP in one of their border cases: i.e. if either the qubit key K or the unknown quantum information in qubits M or both of them consist of qubits in some symmetrical states (e.g. either the basis states |0 [symbol] and |1 [symbol] or |+ [symbol] and |− [symbol] which however represent classical information, or the symmetrical computational basis Bell states which are pairwise quantum entangled, however still with special symmetries related to classical information identified with the states from the basis representing classical information bits). If the above border cases are not realized then the information-theoretic secure encryption upon entanglement will take place by CNOT action of just the single key qubit K on n-qubits quantum message M, transforming it to a jointly entangled state of K′ and M′, and thus M′ will be then fully independent from M, so there is no any possible operation of either measurement or unitary operation to restore the original quantum information M if the adversary (Eve) would not have the single qubit key K′ at her disposal (only the previous existance of some symmetric relations in either K or M qubits to classical information would cause that the independence of M′ from M would not be provided). Indeed the concepts that reduce the herewithin proposed protocol to its border cases are discussed in the mentioned literature (as these border cases are equivalent with the special cases discussed in these publications), especially in [54] as related to limitations regarding the amount of classical information key to securely encrypt n-qubits quantum information (a proof that 2n classical bits is necessary to theoretic-securely encrypt n-qubits which can be generalized to earlier concepts of quantum teleportation and superdense coding in both of which 1 qubit relates with 2 bits of classical information) and in [40] as regarding the result showing then recycling quantum key (however made of symmetrical Bell states or ebits) also resolves to the classical key case limitations (that is to recycling the classical key in the Private Quantum Channel PQC as that paper itself proves). The recycling of the quantum key concept as described in [40] is also limited conceptually in regard to not having the multi-qubit entanglement included within the currently proposed OQP protocol. The main advantage of the OQP proposed protocol lies in its efficiency. Only one arbitraty unknown quantum state (the single quantum key K) is used for quantum-information-theoretic secure encryption of an arbitraty number of n qubits in their arbitraty unknown quantum states. In more fundamental approach upon quantum teleportation, a non-local secure communicating of the n qubits quantum message M will require n entangled qubits shared beforehand for the teleportation of each subsequent qubit of the quantum message M (the entanglement shared between the parties will form a non-local key, however utilizing only 2-qubits pairwise entanglement between qubits in the key the quantum key in such of quantum teleportation can be understood to be distributed between Alice and Bob who both share each qubit out of entangled pair). In the OQP protocol the encryption of the quantum key with the message will form multi-qubit entanglement which should be highlighted as the fundamental difference.

### BRIEF DESCRIPTION OF DRAWINGS

FIG. 1 Quantum One-Time Pad (QOTP), a straightforward generalization of the classical One-Time Pad (OTP) to quantum case is illustrated on the FIG. 1 There are two registers: the register of the quantum message M and the register of the quantum key K, both registers have n qubits. The quantum information encryption operation of the QOTP protocol is based on the pairwise entanglement between subsequent qubits in M and K on their corresponding positions which is introduced by quantum controlled negation (CNOT) gate with the key qubits of K being control qubits and the message qubits of M being target qubits (the concept is presented in section A). In the case that all qubits in M and K are basis states (i.e. represent classical information) the QOTP reduces to classical OTP encryption as the operation of quantum CNOT reduces to classical CNOT (the classical CNOT is equivalent to XOR, just additionally outputting the key bit). If the key register K consists of qubits in unknown quantum states then quantum CNOT will entangle them with the respective qubits of M resulting in jointly pairwise entangled registers of M′ and K′. It is important to stress that in this situation there will be no multi-qubit entanglement, entanglement will be only between the pairs of corresponding M′ and K′ qubits. To decrypt the entangled message M′ one needs to be at disposal of K′ and either use again the CNOT gates or measure the states of K′ register—both operations will disentangle the M′ qubits returning them to original states of the quantum message M register. On the bottom of the FIG. 1 there are represented: the quantum circuit implementing QOTP: n qubits of quantum message M and n qubits of quantum key K are entangled together pairwise by CNOT gates (B) and its two decrypting configurations by measurement (D) or reversal of CNOT gates (E). Additionally there is also a time-like encrypting operation with a single CNOT gate (C).

FIG. 2 The basic idea of the One-Qubit Pad (OQP) protocol and its implementing generic device is to apply CNOT operation with the same single qubit key K as the control qubit but targeting subsequent qubits in n-qubits quantum message register M—this eventually produces a joint (n+1)-qubit entanglement between the key qubit and quantum message as presented in the FIG. 2.

FIG. 3 The implementation of the OQP protocol as a generic device in quantum circuit theory can be referred to the FIG. 3 It should be noted that the quantum circuit scheme of the device doesn't have to rely on n CNOT gates. There could be just a single CNOT gate and single key qubit K′ could be looped to go from the output of control CNOT qubit to its control input in subsequent iterations of n qubits in M fed to the target input of this single CNOT gate (as illustrated on the right of FIG. 3). Nevertheless in the quantum circuit theory the proper representation is given as on the left of the FIG. 3 with step-like form of subsequent CNOT operations entangling qubits of M with the single key qubit K. After the quantum message has been encrypted upon its entanglement with key qubit K′, to decrypt it (disentangle) one must have the key qubit K′ at his disposal, and either reverse the quantum circuit with CNOT gates applied in reversed order, i.e. first for the key qubit K′ and the last qubit in M′ and so on finally up to the key qubit with the first qubit of encrypted quantum message M′, what will disentangle and thus decrypt M′ to original quantum message register M of n-qubits, or to measure the single qubit key K′ (this is illustrated on the FIG. 4)

FIG. 4 The procedure of decryption (disentanglement) by the single key qubit K′ measurement is illustrated on the FIG. 4 upon a quantum circuit representation. The left part of the figure is referring to quantum measurement on the single key qubit K′ that will condition by either −0¿ or −1¿ measurement projection outcome the quantum negation (σₓ Pauli matrices gates) on all qubits in disentangling M (if the key projects to −0¿ the quantum negation is not applied and the M′ is decrypted to original quantum message qubits register M, while in opposite case the quantum negation gate must be applied to all message qubits after disentanglement to decrypt M). The classical output of the measurement of the single key qubit K′ is shown to condition the quantum negation on the quantum message M to decrypt it. On the right section of the figure the reversed order of CNOT operations are presented to also decrypt quantum message M with the single qubit key.

FIG. 5 The application of OQP in secure quantum communication is shown on the FIG. 5 with combining the OQP protocol with the quantum teleportation (QT). For Alice to securely send n-qubits message M to Bob quantum teleportation protocol is good choice. She would need however to pre-share with Bob exactly n pairs of entangled qubits in Bell states. Then each qubit of message M Alice could teleport to Bob non-locally, thus the quantum information in M would remain safe and inaccessible to an adversary (Eve). Additionally for each of the teleported qubit Alice would need to send 2 bits of classical information to let Bob restore the correct state of teleported subsequent qubit of M (altogether for n qubits in teleporting M Alice needs to send 2n bits of classical information). The advantage of the OQP protocol is following: when Alice implements the OQP protocol (runs her n qubits quantum message register M through the OQP generic device thus entangling all qubits of M with the single qubit K, obtaining n+1-qubits jointly entangled state of K′ and M′) she can send the M′ through a standard quantum channel and only securely and non-locally teleport the single qubit key K′. If Eve intercepts quantum message M′ she won't be able to restore the original quantum message M out of M′ without the single key qubit K′ entangled with M′. The key qubit K′ will be however secured from Eve being non-locally teleported to Bob along with 2 bits of classical information to enable Bob to restore the proper state of K′. When Bob gets the single qubit key K′ teleported to him and the message M′ arrives in standard quantum channel (a local one without pre-shared entanglement for n-qubits), he can the use the key to decrypt (disentangle) the quantum message M (by reversing OQP protocol operation or simply measuring the key K′). Thus for secure communication in the latter scenario of OQP only 1 qubit (of the key) needs to be teleported to securely (privately) communicate n-qubits of quantum message (which means Alice and Bob need to share only 1 maximally entangled pair of qubits, the Bell state) in contrast to full teleportation of M which would require Alice and Bob to share n maximally entangled pairs of Bell state qubits). One should point however that this gain (1 pre-shared Bell state and just 2 bits of classical information broadcast to securely send n qubits of quantum message from Alice to Bob with OQP against the n pre-shared Bell states and 2n bits of classical information broadcast to do the same without OQP in the teleportation only scenario) comes at a price. The price in the OQP communication scenario is with the possibility to intercept the encrypted message M′ and destroying or changing it by Eve. It should be stressed however that it won't allow Eve to access the original decrypted quantum message M (one can do this only if at disposal of the single key qubit K′), but Eve will still be able to prevent Bob from receiving the M′ (which is impossible in the teleportation-only scenario, assumed of course that classical communication channel is authenticated and Eve cannot interfere with it, as if she could, then the teleportation won't work properly). Therefore one can have the impression that the communication related applications of OQP are somewhat more limited than general teleportation based secure communication of quantum information. This is however not justified, as it comes evident from the fact that OQP with quantum teleportation of the single qubit key is also much more efficient in terms of required resources: prerequisite of only 1 Bell state shared between Alice and Bob in contrast to n Bell states required for teleportation-only secure communication. In the latter case one needs to provide for a method to distribute the n perfect Bell states between Alice and Bob and this must happen through a normal, local quantum channel. In most extreme situation (Eve completely controls the local quantum channel between Alice and Bob) there is no way to do this, i.e. both QT and OQP are doomed to failure. In less extreme situation this quantum channel for QT Bell states distribution (exactly as in the OQP communication scheme) is a potential subject of only partial adversary manipulation or also decoherence (i.e. the same two issues regarding the quantum channel for sending encrypted M′ in OQP). In case of QT of course Alice and Bob can in principle use the known methods for entanglement distillation [57-63], but this will result in the neccessity to actually exchange many more then n imperfect (decohered or manipulated in the local quantum channel) qubits between them, from a large number of which they can eventually obtain the much smaller number of n perfect Bell states. This is corresponding to the possibility to correct for adversary manipulation or decoherence by introducing some redundancy or more advanced error correction codes into the quantum message M (extending its size from n qubits to much larger number of qubits) then encrypted upon the entanglement based OQP to M′ (thus even if Bob receives partially manipulated or decohered M′ then knowing the state of K′ he will be able to apply quantum error correction to obtain much shorter but true original message M). The discussion of imperfect quantum channels is however out of the scope of the proposed OQP protocol and its generic device (the results from quantum error correction can be applied into the extension of OQP protocol application schemes).

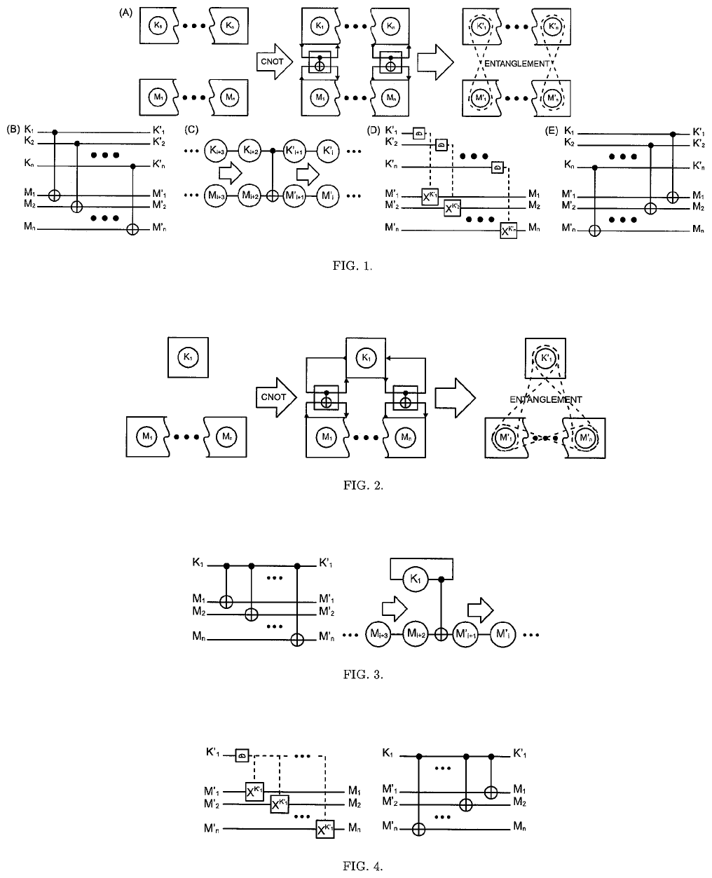

### DESCRIPTION OF EMBODIMENTS

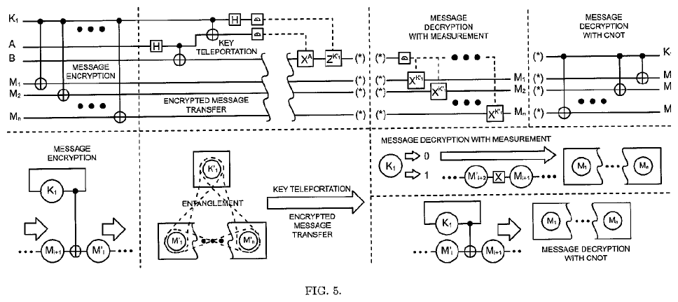

The invention consisting of technical generic device implementing the proposed OQP protocol will use the following components: already maturing in the current-state-of-the-art implemented technically CNOT gates and related to their implementation, implementations of qubits themselves and their quantum channels. The CNOT gates and related to their definitions qubits are implemented for many years (cf. e.g. [15-29]). Building of the generic device implementing the OQP protocol can be realized on any technological implementation of qubits and their CNOT operations and is currently achievable technologically. While the qubits and CNOT gates are basic components of the OQP device, the invention doesn't depend on particular implementation technology used for quantum information carriers (qubits) and interactions between the qubits carriers (implementing CNOT gates). These can be realized in the regimes of orbital or spin degrees of freedom in matter or with polarization or phase degrees of freedom of light, etc. It should be stressed that implementation of OQP protocol/device doesn't require universal quantum computation in principle (only the qubits carriers and the CNOT gate technology is required). The generic device abstracts from the actual realization of its components and even abstracts of physical carriers that will implement qubits. These can be either photon qubits or matter qubits (e.g. atoms, ions, excitons in quantum dots, nucleus, etc. both with their orbital and spin degrees of freedom). It means that the patented device will work in any physically valid implementation of CNOT gates, qubits and their channels. The technical schema of the device is presented in the FIG. 3 and FIG. 4 while implementation in combining with quantum teleportation (also successfully implemented, cf. e.g. [64, 65]) towards secure quantum communication applications is presented in the FIG. 5.

As there are many successful implementations of CNOT gates and qubits the preferred choice for implementation of the generic OQP device lies within photon implementations (e.g. [16, 21-25, 27, 28]), much more sensible for quantum communication scenarios. In OQP case, similarly as in case of quantum cryptography, the device does not need scallable and universal quantum gates architectures assuming noiseless channels. Imperfect quantum channels would require quantum error-correction (cf. e.f. [59, 66]) for M. The scallabe universal quantum computers were not built as of yet, but progress is ongoing and there might be a breakthrough in one of the explored technology regimes, which will support this technology for OQP implementation to be compatible with the successful implementation regime of the universal quantum computer—which technology it will be it is however hard to predict now.

In principle the OQP device can be built on a single CNOT gate in which the single control qubit K (the key qubit) would be looped for n times while n-qubits register of M would be fed sequentially to CNOT interaction with qubit K (this is illustrated on the FIG. 3).

As mentioned the whole setup for utilizing OQP in quantum communication involves also Quantum Teleportation [41] of the single key qubit, and this technology is achievable and already implemented for many years [64], recently from Earth to the orbit as well [65].

### INDUSTRIAL APPLICABILITY

It should be noted that likewise classical OTP the proposed invention of OQP can have applications not only in communication. The OQP can be used as the Quantum Safe (QS), to lock valuable quantum information (this however requires protection from decoherence, i.e. a good implementation of qubit: proper quantum memory). The Quantum Safe is thus a technological device based on the OQP generic device in which some crucial quantum information is being locked by the quantum key. The crucial quantum information is any information of some important value (a result of advanced quantum computation, quantum entanglement currency wallet or any another quantum data that one wants to keep secured from unauthorized access). If the quantum information M is locked in the Quantum Safe by entangling it with the single qubit key, then it cannot be accessed without this key. One interesting property however is that it can be destroyed.

The OQP protocol by itself is not suited for the communication scenario, unless it is combined with quantum teleportation [41], but only of the single key qubit. If Alice and Bob want to communicate and Alice had entangled her quantum message with the single qubit quantum key, then she will need to teleport this single qubit key to Bob (upon the non-local channel of the shared Bell pair) but also additionally send the encrypted message in n qubits register to Bob by insecure quantum channel. If Alice does this, Bob will be able to decrypt (disentangle) the encrypted quantum message register with the single qubit key and thus access the original quantum information (that he can use accordingly, e.g. in his quantum computation). Of course in that situation Eve can eavesdrop on the insecure quantum channel (it should be noted that in contrast to classical eavesdropping in quantum case the eavesdroping is fundamentally different, because since the quantum information cannot be copied guaranteed by the no-cloning theorem [39] to be eveasdropped it must be actually hi-jacked—of course under the assumption of the full man-in-the-middle type of attack when Eve is able to fully impersonate Bob for Alice and Alice for Bob, after hi-jacking encrypted quantum message she still cannot access it, because she is unable to disentangle it from the single qubit key, protected from her by the non-local QT transfer to Bob. The application of OQP in secure quantum communication is shown on the FIG. 5 with combining the OQP protocol with the quantum teleportation (QT).

Normally when Alice would like to securely send n-qubits message M to Bob, she could have used quantum teleportation protocol. However to do this she would need to pre-share with Bob exactly n pairs of entangled qubits in Bell states. Then each qubit of message M Alice could teleport to Bob non-locally, thus the quantum information in M would remain safe and inaccessible by an adversary (Eve). Additionally for each of the teleported qubit Alice would need to send 2 bits of classical information to let Bob restore the correct state of teleported subsequent qubit of M (alltogether for n qubits in teleporting M Alice needs to send 2n bits of classical information). The advantage of the OQP protocol is following: when Alice implements the OQP protocol (runs her n qubits quantum message register M through the OQP generic device thus entangling all qubits of M with the single qubit K, obtaining n+1-qubits jointly entangled state of K′ and M′) she can send the M′ through a standard quantum channel and only securely and non-locally teleport the single qubit key K′. If Eve intercepts quantum message M′ she won't be able to restore the original quantum message M out of M′ without the single key qubit K′ entangled with M′. The key qubit K′ will be however secured from Eve being non-locally teleported to Bob along with 2 bits of classical information to enable Bob to restore the proper state of K′. When Bob gets the single qubit key K′ teleported to him and the message M′ arrives in standard quantum channel (a local one without pre-shared entanglement for n-qubits), he can the use the key to decrypt (disentangle) the quantum message M′ (by reversing OQP protocol operation or simply measuring the key K′). Thus for secure communication in the latter scenario of OQP only 1 qubit (of the key) needs to be teleported to securely (privately) communicate n-qubits of quantum message (which means Alice and Bob need to share only 1 maximally entangled pair of qubits, the Bell state) in contrast to full teleportation of M which would require Alice and Bob to share n maximally entangled pairs of Bell state qubits). One should point however that the gain (1 pre-shared Bell state and just 2 bits of classical information broadcasted to securely send n qubits of quantum message from Alice to Bob with OQP against the n pre-shared Bell states and 2n bits of classical information broadcast to do the same without OQP in the teleportation only scenario) comes at a price. The price in the OQP communication scenario is the possibility to intercept the encrypted message M′ and destroying or changing it by Eve. It should be stressed however that it won't allow Eve to access the original decrypted quantum message M (one can do this only if at disposal of the single key qubit K′), but she will still be able to prevent Bob from receiving the M′ (which is impossible in the teleportation-only scenario, assumed of course that classical communication channel is authenticate and Eve cannot interfere with it, as if she could then the teleportation won't work properly too). Therefore one can have the impression that the communication related applications of OQP are somewhat more limited than general teleportation based secure communication of quantum information. This is however not fully justified, as it comes evident from the fact that OQP with quantum teleportation of the single qubit key is also much more efficient in terms of required resources: prerequisite of only 1 Bell state shared between Alice and Bob in contrast to n Bell states required for teleportation-only secure communication. In the latter case one needs to provide for a method to distribute the n perfect Bell states between Alice and Bob and this must happen through a normal, local quantum channel (without pre-sharing of the entanglement). In most extreme situation (Eve completely controls the local quantum channel between Alice and Bob) there is no way to do this, i.e. both QT and OQP are doomed to failure. In less extreme situation this quantum channel for QT Bell states distribution (exactly as in the OQP communication scheme) is a potential subject of only partial adversary manipulation or also decoherence (i.e. the same two issues regarding the quantum channel for sending encrypted M′ in OQP). In case of QT of course Alice and Bob can in principle use the known methods for entanglement distillation [57-63], but this will result in the neccessity to actually exchange many more than n imperfect (decohered or manipulated in the local quantum channel) qubits between them, from a large number of which they can eventually obtain the much smaller number of n perfect Bell states. This is effectively similar to the possibility to correct for adversary manipulation or decoherence by introducing some redundancy or more advanced error correction codes into the quantum message M (extending its size from n qubits to much larger number of qubits) then encrypted upon the entanglement based OQP to M′ (thus even if Bob receives partially manipulated or decohered M′ then knowing the state of K′ he will be able to apply quantum error procedures to obtain much shorter but true original message M). The discussion of imperfect quantum channels is however out of the scope of the proposed OQP protocol and its generic device (the results from quantum error correction [59, 66] can be applied into the extension of OQP protocol application schemes).

### LITERATURE

[1] P. W. Shor. Algorithms for quantum computation: discrete logarithms and factoring. In Proceedings 35th Annual Symposium on Foundations of Computer Science, pages 124-134, 1994.
[2] A. Yu. Kitaev. Quantum measurements and the abelian stabilizer problem. ArXiv e-prints, 1995. arXiv:quant-ph/9511026.
[3] C. H. Bennett and G. Brassard. Quantum cryptography: Public key distribution and coin tossing. In Proceedings of IEEE International Conference on Computers, Systems and Signal Processing, pages 175-179, 1984.
[4] Artur K. Ekert. Quantum cryptography based on Bell's theorem. Phys. Rev. Lett., 67:661-663, 1991.
[5] Charles H. Bennett. Quantum cryptography using any two nonorthogonal states. Phys. Rev. Lett., 68:3121-3124, 1992.
[6] Hoi-Kwong Lo and H. F. Chau. Unconditional security of quantum key distribution over arbitrarily long distances. Science, 283:2050-2056, 1999.
[7] L. M. K. Vandersypen, M. Steffen, G. Breyta, C. S. Yannoni, M. H. Sherwood, and I. L. Chuang. Experimental realization of Shor's quantum factoring algorithm using nuclear magnetic resonance. Nature, 414:883, 2001.
[8] Technical roadmap for quant. computing, UK National Quant. Tech. Programme Networked Quantum Information Technologies. http://www.nqit.ox.ac.uk/sites/www.nqit.ox.ac.uk/files/2016-11/NQITTechnicalRoadmap.pdf
[9] M. W. Johnson, M. H. S. Amin, S. Gildert, T. Lanting, F. Hamze, N. Dickson, R. Harris, A. J. Berkley, J. Johansson, P. Bunyk, E. M. Chapple, C. Enderud, J. P. Hilton, K. Karimi, E. Ladizinsky, N. Ladizinsky, T. Oh, I. Perminov, C. Rich, M. C. Thom, E. Tolkacheva, C. J. S. Truncik, S. Uchaikin, J. Wang, B. Wilson, and G. Rose. Quantum annealing with manufactured spins. Nature, 473:194, 2011.
[10] B. D. Josephson. Possible new effects in superconductive tunnelling. Phys. Lett., 1:251-253, 1962.
[11] C. Choi. Google and NASA launch quantum computing AI lab: The Quantum Artificial Intelligence Lab will use the most advanced commercially available quantum computer, the D-Wave Two, technology review. https://www.youtube.com/watch?v=CMdHDHEuOUE, 2013.
[12] Elizabeth Gibney. Europes billion-euro quantum project takes shape. Nature, 545:16, 2017.
[13] David P. DiVincenzo. The physical implementation of quantum computation. Fortschr. Phys., 48:771-783, 2000.
[14] D. Genkin, A. Shamir, and E. Tromer. RSA Key Extraction via Low-Bandwidth Acoustic Cryptanalysis. Springer, Berlin, 2014.
[15] D. M. Zajac, A. J. Sigillito, M. Russ, F. Borjans, J. M. Taylor, G. Burkard, and J. R. Petta. Resonantly driven CNOT gate for electron spins. Science, 2017.
[16] Serge Rosenblum, Yvonne Y. Gao, Philip Reinhold, Chen Wang, Christopher J. Axline, Luigi Frunzio, Steven M. Girvin, Liang Jiang, Mazyar Mirrahimi, Michel H. Devoret, and Robert J. Schoelkopf. A CNOT gate between multiphoton qubits encoded in two cavities. ArXiv e-prints, 2017. arXiv:1709.05425 [quant-ph].
[17] Yan Liang, Chong Song, Xin Ji, and Shou Zhang. Fast CNOT gate between two spatially separated atoms via shortcuts to adiabatic passage. Opt. Express, 23:23798-23810, 2015.
[18] Cristian Bonato, Florian Haupt, Sumant S. R. Oemrawsingh, Jan Gudat, Dapeng Ding, Martin P. van Exter, and Dirk Bouwmeester. Cnot and bell-state analysis in the weak-coupling cavity qed regime. Phys. Rev. Lett., 104:160503, 2010.
[19] L. Isenhower, E. Urban, X. L. Zhang, A. T. Gill, T. Henage, T. A. Johnson, T. G. Walker, and M. Saffman. Demonstration of a neutral atom controlled-not quantum gate. Phys. Rev. Lett., 104:010503, 2010.
[20] J. H. Plantenberg, P. C. de Groot, C. J. P. M. Harmans, and J. E. Mooij. Demonstration of controlled-NOT quantum gates on a pair of superconducting quantum bits. Nature, 447:836, 2007.
[21] Li-Ping Deng, Haibo Wang, and Kaige Wang. Quantum CNOT gates with orbital angular momentum and polarization of single-photon quantum logic. J. Opt. Soc. Am. B, 24:2517-2520, 2007.
[22] Z. Zhao, A.-N. Zhang, Y.-A. Chen, H. Zhang, J.-F. Du, T. Yang, and J.-W. Pan. Experimental demonstration of a nondestructive controlled-NOT quantum gate for two independent photon qubits. Phys. Rev. Lett., 94:030501, 2005.
[23] Marco Fiorentino and Franco N. C. Wong. Deterministic controlled-not gate for single-photon two-qubit quantum logic. Phys. Rev. Lett., 93:070502, 2004.
[24] Sara Gasparoni, Jian-Wei Pan, Philip Walther, Terry Rudolph, and Anton Zeilinger. Realization of a photonic controlled-not gate sufficient for quantum computation. Phys. Rev. Lett., 93:020504, 2004.
[25] Kae Nemoto and W. J. Munro. Nearly deterministic linear optical controlled-not gate. Phys. Rev. Lett., 93:250502, 2004.
[26] Ferdinand Schmidt-Kaler, Hartmut Haffner, Mark Riebe, Stephan Guide, Gavin P. T. Lancaster, Thomas Deuschle, Christoph Becher, Christian F. Roos, Jurgen Eschner, and Rainer Blatt. Realization of the Cirac-Zoller controlled-NOT quantum gate. Nature, 422:408, 2003.
[27] T. B. Pittman, M. J. Fitch, B. C Jacobs, and J. D. Franson. Experimental controlled-not logic gate for single photons in the coincidence basis. Phys. Rev. A, 68:032316, 2003.
[28] J. L. O'Brien, G. J. Pryde, A. G. White, T. C. Ralph, and D. Branning. Demonstration of an all-optical quantum controlled-NOT gate. Nature, 426:264, 2003.
[29] D. DeMille. Quantum computation with trapped polar molecules. Phys. Rev. Lett., 88:067901, 2002.
[30] U.S. Pat. No. 1,310,719 A (1919).
[31] U.S. Pat. No. 388,244 A (1888) and French Patent No. 146,716 (1882).
[32] C. E. Shannon. Communication theory of secrecy systems. Bell Sys. Tech. J., 28:656-715, 1949.
[33] K. Melville. Securing record communications: The tsec/kw-26. www.jproc.ca/crypto/kw26.pdf, 2004.
[34] W. Diffie and M. Hellman. New directions in cryptography. IEEE Trans. Inf. Theor., 22:644-654, 1976.
[35] R. L. Rivest, A. Shamir, and L. Adleman. A method for obtaining digital signatures and public-key cryptosystems. Commun. ACM, 26:96-99, 1983.
[36] V. S. Miller. Use of Elliptic Curves in Cryptography. Springer, Berlin, 1986.
[37] Accredited standards committee X9, american national standard X9.62-2005, public key cryptography for the financial services industry, the elliptic curve digital signature algorithm ECDSA, 2005.
[38] A. Einstein, B. Podolsky, and N. Rosen. Can quantum-mechanical description of physical reality be considered complete? Phys. Rev., 47:777-780, 1935.
[39] W. K. Wootters and W. H. Zurek. A single quantum cannot be cloned. Nature, 299:802, 1982.
[40] D. W. Leung. Quantum Vernam cipher. Quant. Inf. Computat., 2:14-32, 2002.
[41] Charles H. Bennett, Gilles Brassard, Claude Crépeau, Richard Jozsa, Asher Peres, and William K. Wootters. Teleporting an unknown quantum state via dual classical and Einstein-Podolsky-Rosen channels. Phys. Rev. Lett., 70:1895-1899, 1993.
[42] M. Nielsen and I. Chuang. Quantum computation and quantum information. Amer. J. of Phys., 70:558, 2002.
[43] J. Jacak, I. Jóźwiak, and L. Jacak. New implementation of composite fermions in terms of subgroups of a braid group. Phys. Lett. A, 374:346-350, 2009.
[44] J. Jacak, R. Gonczarek, L. Jacak, and I. Jóźwiak. Application of braid groups in 2D Hall system physics; composite fermion structure. WorldScientific, Singapore, 2012.
[45] Janusz Jacak. Unconventional fractional quantum hall efect in bilayer graphene. Sci. Rep., 7:8720, 2017.
[46] Frank Wilczek. Quantum mechanics of fractional-spin particles. Phys. Rev. Lett., 49:957-959, 1982.
[47] Jonathan Oppenheim and Michal Horodecki. How to reuse a one-time pad and other notes on authentication, encryption, and protection of quantum information. Phys. Rev. A, 72:042309, 2005.
[48] Charles H. Bennett and Stephen J. Wiesner. Communication via one- and two-particle operators on Einstein-Podolsky-Rosen states. Phys. Rev. Lett., 69:2881-2884, 1992.
[49] F.-G. Deng and G. L. Long. Secure direct communication with a quantum one-time pad. Phys. Rev. A, 69:052319, 2004.
[50] Benjamin Schumacher and Michael D. Westmoreland. Quantum mutual information and the one-time pad. Phys. Rev. A, 74:042305, 2006.
[51] Bin Gu, ChengYi Zhang, GuoSheng Cheng, and YuGai Huang. Robust quantum secure direct communication with a quantum one-time pad over a collective-noise channel. Sci. China Phys. Mech. Astron., 54:942, 2011.
[52] Fernando G. S. L. Brandao and Jonathan Oppenheim. Quantum one-time pad in the presence of an eavesdropper. Phys. Rev. Lett., 108:040504, 2012.
[53] K. Sharma, E. Wakakuwa, and M. M. Wilde. Conditional quantum one-time pad. ArXiv e-prints, 2017. arXiv:1703.02903.
[54] A. Ambainis, M. Mosca, A. Tapp, and R. De Wolf. Private quantum channels. In Proceedings 41st Annual Symposium on Foundations of Computer Science, pages 547-553, 2000.
[55] P. Oscar Boykin and Vwani Roychowdhury. Optimal encryption of quantum bits. Phys. Rev. A, 67:042317, 2003.
[56] H. Barnum, C. Crepeau, D. Gottesman, A. Smith, and A. Tapp. Authentication of quantum messages. In The 43rd Annual IEEE Symposium on Foundations of Computer Science, 2002. Proceedings., pages 449-458, 2002.
[57] Charles H. Bennett, Herbert J. Bernstein, Sandu Popescu, and Benjamin Schumacher. Concentrating partial entanglement by local operations. Phys. Rev. A, 53:2046-2052, 1996.
[58] Charles H. Bennett, Gilles Brassard, Sandu Popescu, Benjamin Schumacher, John A. Smolin, and William K. Wootters. Purification of noisy entanglement and faithful teleportation via noisy channels. Phys. Rev. Lett., 76:722-725, 1996.
[59] Charles H. Bennett, David P. DiVincenzo, John A. Smolin, and William K. Wootters. Mixed-state entanglement and quantum error correction. Phys, Rev. A, 54:3824-3851, 1996.
[60] Paul G. Kwiat, Salvador Barraza-Lopez, André Stefanov, and Nicolas Gisin. Experimental entanglement distillation and ‘hidden’ non-locality. Nature, 409:1014, 2001.
[61] J.-W. Pan, C. Simon, C. Brukner, and A. Zeilinger. Entanglement purification for quantum communication. Nature, 410:1067, 2001.
[62] Takashi Yamamoto, Masato Koashi, Sahin Kaya ozdemir, and Nobuyuki Imoto. Experimental extraction of an entangled photon pair from two identically decohered pairs. Nature, 421:343, 2003.
[63] Jian-Wei Pan, Sara Gasparoni, Rupert Ursin, Gregor Weihs, and Anton Zeilinger. Experimental entanglement purification of arbitrary unknown states. Nature, 423:417, 2003.
[64] Dik Bouwmeester, Jian-Wei Pan, Klaus Mattle, Manfred Eibl, Harald Weinfurter, and Anton Zeilinger. Experimental quantum teleportation. Nature, 390:575, 1997.
[65] J.-G. Ren, P. Xu, H.-L. Yong, L. Zhang, S.-K. Liao, J. Yin, W.-Y. Liu, W.-Q. Cai, M. Yang, L. Li, K.-X. Yang, X. Han, Y.-Q. Yao, J. Li, H.-Y. Wu, S. Wan, L. Liu, D.-Q. Liu, Y.-W. Kuang, Z.-P. He, P. Shang, C. Guo, R.-H. Zheng, K. Tian, Z.-C. Zhu, N.-L. Liu, C.-Y. Lu, R. Shu, Y.-A. Chen, C.-Z. Peng, J.-Y. Wang, and J.-W. Pan. Ground-to-satellite quantum teleportation. Nature, 549:70, 2017.
[66] Peter W. Shor. Scheme for reducing decoherence in quantum computer memory. Phys. Rev. A, 52:R2493R2496, 1995.
[67] G. Cantor. Ueber eine eigenschaft des inbegriffes aller reellen algebraischen zahlen. J. Reine Angew. Math., 77:258-262, 1874.
[68] D. M. Greenberger, M. A. Horne, and Zeilinger A. Going Beyond Bells Theorem. Springer, Dordrecht, 1989.

1. The invented One-Qubit Pad (OQP) protocol and its generic implementing device describe how to securely (with quantum-information-theoretic security) encrypt (upon multi-qubit entanglement) the unknown quantum information (message) of n qubits register (M) in arbitrary states with just a single key qubit (K) in unknown arbitrary quantum superposition. This is a novel result in terms of technical invention and application of Quantum Information not described in the literature previously. The main application of the protocol and its related generic device is to lock the quantum information M with the key K of just a single qubit in order to disallow any potential access to the original n qubits quantum information M by an adversary (e.g. the quantum information M might be some valuable output of quantum computation and it should be locked from an adversary disallowing him to use it as an input in his quantum computation).

2. The proposed OQP protocol and device prove that quantum information is very distinct from classical information upon showing that generalization of the classical One-Time Pad (upon Vernam's cipher) to the quantum case can be reduced to just One-Qubit Pad (a single qubit is only required to serve as the key, still offering unconditional, i.e. information-theoretic security of encrypted quantum message). One doesn't need to use unknown n-qubits (or even 2n-qubits) states for the key to securely encrypt unknown quantum information of n-qubits: just one key qubit is sufficient but this is due to utilization of the multi-qubit (n+1-qubits) entanglement of the whole joint state of both the key qubit and message qubits (in the known from literature scenarios for encryption of quantum information there is prominently used the pairwise, i.e. 2-qubits entanglement). The proposed invention shows that introducing multi-qubit entanglement by cyclically applying CNOT gate upon the single key qubit K (control qubit) and the subsequent qubits in M (target qubits) can reduce the number of the required key qubits to only one. Additional qualitative difference of the proposed OQP protocol in relation to fully or partly classical encryption protocols (e.g. of quantum information encryption using classical keys, known as Quantum Private Channels or PQC as introduced in [54]) is that both the message and key are quantum information and thus are prohibited to be copied by quantum mechanics laws (the no-cloning theorem [39]). E.g. in PQC schemes the security is not fully information-theoretic because one cannot guarantee that the used classical information key has not been copied, which is precluded on the fundamental level in the proposed OQP protocol, due to its operation on the fully quantum single qubit key.

3. The invention is based upon not widely discussed in the literature uncountable information capacity of the single qubit in contrast to single bit (which is of a countable and finite capacity: just 2 possible values 0 and 1). The qubit itself is a linear combination of two complex numbers fulfilling normalization condition (or upon the Bloch sphere representation of qubit: of real numbers and phase factors). The possible numbers defining the single qubit are thus of the continuous set of uncountable infinite cardinal number of possible values (the cardinal number of the continuum is c). This means that one single qubit can hide uncoutably infinite classical information in its single own quantum state. From the proofs of Cantor [67] it follows that: 1) continuum cardinal number is c= [symbol] (where [symbol] ₀ is the cardinal number of the countable set of natural numbers) and 2) that for any two real numbers a>b in any open interval between them: (a, b), no matter how close they are, there are always infinite number of other real numbers set elements, but with the same cardinality of the infinite as the whole real numbers set (the number c). This means that also any countable number of such intervals will have jointly equinumerous elements as the whole set of the real numbers (similarly the countably many sets of real numbers will be equinumerous jointly with their elements with a single set of real numbers). This also applies to qubits: since the countable infinite sets of n-qubits are of No cardinality, the set of n qubits, even if n is infinite but still countable, will thus have the same information capacity as a single qubit: both sets of infinities are equinumerous, i.e. the infinite information capacity of single qubit is equinumerous with the infinite capacity of n qubits set. This deep mathematical relation in the framework of Cantor's and later work on the infinities in the set theory constitutes a fundamental observation for the proposed invention to use only a single unknown arbitraty qubit (the single qubit key) to quantum-information-theoretically securely encrypt in entanglement an unknown arbitrary n qubits information (message) within the invented One-Qubit Pad (OQP) protocol, even if the message is infinitely long (i.e. the number of qubits is infinite, however countable).

4. The OQP protocol and its generic device can be implemented very conveniently by just a single CNOT gate with the control qubit being the looped single key qubit (the subsequent n qubits of the quantum message M would be synchronically fed to target qubit input of this single CNOT gate) and even more importantly the protocol offers just a single key qubit K′ to securely manage its secrecy. To decrypt the encrypted (entangled) quantum message it is not even necessary to reverse the application of the CNOT gate—one only needs to measure the single qubit key and upon the measurement outcome either restore the original quantum message M or negate all qubits of the M register to restore them to their original state (in case of projecting the key qubit to the state −1¿ upon its measurement). No other quantum cryptographic scheme as yet discussed in the existing literature had this property: to decrypt n qubits quantum message by the measurement of just a single qubit (which is due to special symmetry of the involved multi-qubit entanglement).

5. The described invention of OQP is based on a special topology of the multi-qubit (n+1-qubits) entanglement between the single qubit key and n qubits in the quantum message M. This topology can be illustratively described as a non local ring of keys: if the ring is cut then all encrypted message qubits (illustratively small individual keys) are freed and decrypted, when the ring is not cut then all message qubits are non-locally bound to the ring (single key qubit) and are themselves illustratively the small keys trapping the original quantum message individual qubits—they are not accessible without the non-local ring (the single key qubit kept private and away from the adversary). Such a topological model of entanglement (however non-symmetrical in contrast to e.g. the generalized GHZ states [68]) is claimed to be an important theoretical feature of the proposed invention of the OQP scheme.

6. The OQP invention allows to significantly reduce the number of required pre-shared Bell states qubits for secure communication of the quantum message: in the standard quantum teleportation-only secure communication scheme to securely send n qubits of quantum message Alice is required to share n Bell states with Bob to individually teleport all n qubits of M to Bob (thus also exchanging 2n bits of classical information that will allow Bob to restore the correct original state of M). The QT scheme could be understood as generalized quantum analog of the classical OTP encryption with the quantum key being the n Bell states (or 2n maximally pairwise entangled qubits). In the case of OQP only one pre-shared Bell state is required to non-locally teleport the key (and thus also 2 bits of classical information) while the encrypted (by the n+1-qubits entanglement with K′) M′ quantum message can be sent through a standard local quantum channel and still be completely inaccessible to Eve (who cannot decrypt the M′ message without the key qubit K′).

7. The actual building of the generic device implementing the OQP protocol can be realized on any technological implementation of qubits and their CNOT operations and is currently achievable technologically (there are many successfully implemented qubits and their CNOT gates, cf. e.g. [15-29]). The qubits and CNOT gates are basic components of the OQP device and the invention doesn't depend on particular implementation technology used for quantum information carriers (qubits) and interactions between the qubits carriers (implementing CNOT gates). These can be realized e.g. in the regimes of orbital or spin degrees of freedom in matter or with polarization or phase degrees of freedom of light. It should be stressed that implementation of OQP protocol/device doesn't require universal quantum computation in principle (only the qubits carriers and the CNOT gate technology is required).
